(19) United States
(12) Patent Application Publication
(10) Pub. No.: US 2025/0346757 A1
(43) Pub. Date: Nov. 13, 2025

(54) RESIN COMPOSITION

(71) Applicant: NAN YA PLASTICS CORPORATION, Taipei City (TW)

(72) Inventors: Ching-Yao Yuan, Taipei City (TW); Yi-Je Tsai, Taipei City (TW); Li Yun Chen, Taipei City (TW); Hung-Yi Chang, Taipei City (TW); Chia-Lin Liu, Taipei City (TW)

(73) Assignee: NAN YA PLASTICS CORPORATION, Taipei City (TW)

(21) Appl. No.: 18/676,464

(22) Filed: May 28, 2024

(30) Foreign Application Priority Data
May 8, 2024 (TW) 113116985

(51) Int. Cl. C08L 71/12; C08K 3/34; C08K 5/14

(52) U.S. Cl. CPC C08L 71/123; C08L 2203/20; C08L 2205/025; C08L 2205/035

(57) ABSTRACT

A resin composition includes a base resin and a hardened resin. The base resin includes a polyphenylene ether resin and an olefinic resin. A weight proportion of the base resin in the resin composition is between 10 wt % and 20 wt %. The hardened resin includes a cyclopentadiene-styrene copolymer resin, a triallyl isocyanurate, and a maleimide resin. A weight proportion of the hardened resin in the resin composition is between 10 wt % and 20 wt %.

### CROSS-REFERENCE TO RELATED APPLICATION

This application claims the priority benefit of Taiwan application serial no. 113116985, filed on May 8, 2024. The entirety of the above-mentioned patent application is hereby incorporated by reference herein and made a part of specification.

### BACKGROUND OF THE INVENTION

### Field of the Invention

The invention relates to a resin composition.

### Description of Related Art

In recent years, with the rapid development of integrated circuit (IC) techniques, the requirements for wiring density (L/S) and transmission rate of chips (such as high-speed computing chips) have increased. Moreover, in order to be more suitable for applications in high-frequency and fast transmission fields, the requirements for low dielectric properties of resin compositions are also increasing.

### SUMMARY OF THE INVENTION

The invention provides a resin composition that may have better roughness and peel strength while maintaining low dielectric properties.

A resin composition of the invention includes a base resin and a hardened resin. The base resin includes a polyphenylene ether resin and an olefinic resin. A weight proportion of the base resin in the resin composition is between 10 wt % and 20 wt %. The hardened resin includes a cyclopentadiene-styrene copolymer resin, a triallyl isocyanurate, and a maleimide resin. A weight proportion of the hardened resin in the resin composition is between 10 wt % and 20 wt %.

In an embodiment of the invention, a molecular weight of the maleimide resin is between 300 and 1800.

In an embodiment of the invention, a weight proportion of the cyclopentadiene-styrene copolymer resin in the hardened resin is between 30 wt % and 50 wt %, a weight proportion of the triallyl isocyanurate in the hardened resin is between 25 wt % and 35 wt %, and a weight proportion of the maleimide resin in the hardened resin is between 25 wt % and 35 wt %.

In an embodiment of the invention, the polyphenylene ether resin includes a methacrylate polyphenylene ether resin, an oligophenylene ether, or a combination thereof, and the olefinic resin includes an allylated phenol resin.

In an embodiment of the invention, the resin composition further includes an initiator. A weight proportion of the initiator in the resin composition is between 0.1 wt % and 0.2 wt %.

In an embodiment of the invention, the resin composition further includes an inorganic filler material. A weight proportion of the inorganic filler material in the resin composition is between 60 wt % and 80 wt %.

In an embodiment of the invention, a content of the cyclopentadiene-styrene copolymer resin in the hardened resin is greater than a content of the triallyl isocyanurate in the hardened resin and a content of the maleimide resin in the hardened resin.

In an embodiment of the invention, a content of the base resin in the resin composition is greater than a content of the hardened resin in the resin composition.

In an embodiment of the invention, a weight proportion of the polyphenylene ether resin in the base resin is between 75 wt % and 85 wt %, and a weight proportion of the olefinic resin in the base resin is between 15 wt % and 25 wt %.

In an embodiment of the invention, a content of the polyphenylene ether resin in the base resin is greater than a content of the olefinic resin in the base resin.

Based on the above, in the invention, the improved hardened resin is introduced into the resin system of the polyphenylene ether resin and the olefinic resin, and via the combination of the cyclopentadiene-styrene copolymer resin, the triallyl isocyanurate, and the maleimide resin, the resin composition may have better roughness and peel strength while maintaining low dielectric properties.

In order to make the aforementioned features and advantages of the disclosure more comprehensible, embodiments accompanied with figures are described in detail below.

### DESCRIPTION OF THE EMBODIMENTS

In the following detailed description, for purposes of illustration and not limitation, exemplary embodiments disclosing specific details are set forth in order to provide a thorough understanding of the various principles of the invention. It will be apparent, however, to one of ordinary skill in the art, having the benefit of this disclosure, that the invention may be practiced in other embodiments that depart from the specific details disclosed herein.

Unless otherwise stated, the term “between” used in this specification to define numerical ranges is intended to cover ranges equal to and between the stated endpoints. For example, if a size range is between a first value and a second value, it means that the size range may cover the first value, the second value, and any value between the first value and the second value.

Unless otherwise defined, all terms (including technical and scientific terms) used herein have the same meaning as commonly understood by those skilled in the art to which this invention belongs.

In the present embodiment, the resin composition includes a base resin and a hardened resin (can be regarded as a hardener), wherein the weight proportion of the base resin in the resin composition is between 10 wt % and 20 wt %, and the weight proportion of the hardened resin in the resin composition is between 10 wt % and 20 wt %. Furthermore, the base resin includes a polyphenylene ether resin and an olefinic resin, and the hardened resin includes a cyclopentadiene-styrene copolymer resin, a triallyl isocyanurate, and a maleimide resin (such as bismaleimide resin (BMI)). Accordingly, in the present embodiment, the improved hardened resin is introduced into the resin system of the polyphenylene ether resin and the olefinic resin, and via the combination of the cyclopentadiene-styrene copolymer resin, the triallyl isocyanurate, and the maleimide resin, the resin composition may have better roughness and peel strength while maintaining low dielectric properties.

In some embodiments, the molecular weight of the maleimide resin is between 300 and 1800 to have better electrical performance, but the invention is not limited thereto.

In some embodiments, the maleimide resin may be a commercially-available product, such as “NE-X-9470S” made by DIC, “NE-X-9500” made by DIC, “MIR-3000” made by Nippon Kayaku, “MIR-5000” made by Nippon Kayaku, “SE-55” made by KI Chemical Co., Ltd., wherein since the main chain structure of “NE-X-9470S” made by DIC is longer, lower dielectric loss may be achieved, but the invention is not limited thereto.

In some embodiments, the weight proportion of the cyclopentadiene-styrene copolymer resin in the hardened resin is between 30 wt % and 50 wt %, the weight proportion of the triallyl isocyanurate in the hardened resin is between 25 wt % and 35 wt %, and the weight proportion of the maleimide resin in the hardened resin is between 25 wt % and 35 wt %, but the invention is not limited thereto.

In some embodiments, the content of the cyclopentadiene-styrene copolymer resin in the hardened resin is greater than the content of the triallyl isocyanurate in the hardened resin and the content of the maleimide resin in the hardened resin, but the invention is not limited thereto.

In some embodiments, the content of the base resin in the resin composition is greater than the content of the hardened resin in the resin composition, but the invention is not limited thereto.

In some embodiments, the polyphenylene ether resin includes a methacrylate polyphenylene ether resin, an oligophenylene ether, or a combination thereof, and the olefinic resin includes an allylated phenol resin, but the invention is not limited thereto.

In some embodiments, the weight proportion of the polyphenylene ether resin in the base resin is between 75 wt % and 85 wt %, and the weight proportion of the olefinic resin in the base resin is between 15 wt % and 25 wt %, but the invention is not limited thereto.

In some embodiments, the content of the polyphenylene ether resin in the base resin is greater than the content of the olefinic resin in the base resin, but the invention is not limited thereto.

In some embodiments, the resin composition further includes an initiator, wherein the weight proportion of the initiator in the resin composition is between 0.1 wt % and 0.2 wt %. For example, the initiator includes 1,3-bis(butylperoxyisopropyl)benzene, but the invention is not limited thereto and other suitable peroxides may also be adopted.

In some embodiments, the resin composition further includes an inorganic filler material, wherein the weight proportion of the inorganic filler material in the resin composition is between 60 wt % and 80 wt %. For example, the inorganic filler material includes silicon oxide, but the invention is not limited thereto and other suitable fillers may also be adopted.

It should be noted that the resin composition may be regarded as a non-volatile component in the resin composition (varnish-like) dissolved in the solvent, and when the non-volatile component is 100 wt %, the content of the inorganic filler material is greater than or equal to 70 wt %, but the invention is not limited thereto. Moreover, the resin composition of the invention may be processed into a prepreg and a copper foil substrate (CCL) according to actual design requirements, and the specific implementations listed above are not limitations of the invention.

The following examples and comparative example are given to illustrate the effects of the invention, but the patent scope of the invention is not limited to the scope of the examples.

The products of each Example and Comparative example were evaluated according to the following method.

Dielectric constant Dk, dielectric loss Df: the above resin films were heated at 200° C. for 90 minutes to form cured films. The cured films were cut into a size of 10 mm in length and 7 mm in width. According to the standard test method of IPC-TM-650 (method 2.5.5.3), the dielectric constant (Dk, & r) and the dielectric loss (dissipation factor, Df, Tan d) of the material under a 10 GHz signal were measured.

Coefficient of thermal expansion (CTE) (x-y plane direction): using a thermomechanical analyzer (TMA), the coefficient of thermal expansion, that is, X-Y CTE (ppm/° C.) of the material in the X-Y plane was measured according to the standard test method of IPC-TM-650 2.4.24. The temperature rising range condition of the test was 40° C. to 120° C.

Coefficient of thermal expansion (CTE) (z plane direction): using a thermomechanical analyzer (TMA), the coefficient of thermal expansion, that is, Z CTE (ppm/° C.) of the material in the Z plane was measured according to the standard test method of IPC-TM-650 2.4.24. The temperature rising range condition of the test was 50° C. to 260° C.

Glass transition temperature (Tg) (C): the glass transition temperature Tg (° C.) of the material was measured using a thermomechanical analyzer (TMA) according to the standard test method of ASTM E1545.

Resin sheet lamination and curing: a glass cloth epoxy resin substrate having a copper foil was prepared as the inner substrate, and both sides were coated with copper lamination (“NPG-180INBK” manufactured by Nan Ya Co., Ltd.), and the surface copper foil of the inner substrate was roughened. Using a vacuum laminator (“V-130” manufactured by Nikko-Material Co., Ltd.), the resin composition and the inner layer substrate were bonded via a vacuum laminator. The conditions were: after the pressure was reduced to 1 hPa or less for 30 seconds, lamination was performed for 60 seconds at a temperature of 100° C./pressure of 100 N. Subsequently, the product was heated in an oven at 130° C. for 30 minutes, and then moved to an oven at 165° C. for 30 minutes. The resin composition was cured by the above heating to obtain an “evaluation substrate A”.

De-smear treatment: in order to roughen the cured resin sheet substrate, the evaluation substrate A was immersed in Sweller 7810 manufactured by DuPont at 70° C. for 10 minutes. Next, the evaluation substrate A was immersed in Promotor 7820 manufactured by DuPont at 85° C. for 10 minutes. Lastly, the evaluation substrate A was immersed in Neutralizer 7831 manufactured by DuPont at 40° C. for 5 minutes to obtain an “evaluation substrate B” after the de-smear treatment.

Forming of plated conductive layer: in order to form a copper plating layer (second conductive layer) at the surface of the evaluation substrate B, the evaluation substrate B was immersed in an electroless plating solution containing PdCl₂ at 40° C. for 5 minutes, and then immersed in an electroless copper plating solution at 25° C. for 20 minutes. The resulting evaluation substrate B was annealed by heating at 150° C. for 30 minutes, and then copper sulfate electrolytic plating was performed to form a copper plating layer having a thickness of 30 μm. The evaluation substrate B on which the copper plating layer was formed was annealed at 190° C. for 60 minutes. The resulting substrate was named “evaluation substrate C”.

Roughness Ra (nm): using a laser conjugate focus microscope (VK-X3000 manufactured by Keyence Corporation), the evaluation substrate B was measured under a 50× lens, and 10 points were randomly selected to measure the arithmetic mean roughness Ra.

Peel strength (lbf/in): a cutout of a 10 mm wide and 100 mm long portion was formed at the copper plating layer of the evaluation substrate C, one end thereof was peeled off and clamped with a clamp, and using a tensile testing machine (“AC-50C-SL” manufactured by TSE Corporation), the load when peeling 35 mm in the vertical direction at a speed of 50 mm/min at room temperature (25° C.) was measured.

### Examples 1 to 5, Comparative Example 1

The resin compositions shown in Table 1 were dissolved in the solvent (toluene) to form liquid (varnish-like) resin compositions, and then the resin compositions were coated on the support (PET release film) using a mouth-mode coater. After drying to form film layers, properties such as dielectric constant, dielectric loss, coefficient of thermal expansion, glass transition temperature, peel strength, and chemical resistance were evaluated. The results thereof are shown in Table 1. After comparing the results of Examples 1 to 5 and Comparative example 1 of Table 1, the following conclusion may be drawn: in the resin compositions of Example 1 to Example 5, the improved hardened resin was introduced into the resin system of the polyphenylene ether resin and the olefinic resin, and via the combination of the cyclopentadiene-styrene copolymer resin, the triallyl isocyanurate, and the maleimide resin, the resin composition may have better roughness and peel strength while maintaining low dielectric properties. For example, the dielectric loss (Df) of the preferred Example 1 may reach 0.0019, and the coefficient of thermal expansion may reach 17.8 ppm/° C.

TABLE 1

| | | | | | | | Comparative |
|---|---|---|---|---|---|---|---|
| | | Example | | | | | example |
| | | 1 | 2 | 3 | 4 | 5 | 1 |
| Base resin | Olefinic resin (allylated | 2.98 | 2.98 | 2.98 | 2.98 | 2.98 | 2.98 |
| | phenol resin, LVA01) (parts | | | | | | |
| | by weight) | | | | | | |
| | Polyphenylene ether resin | 6.27 | 6.27 | 6.27 | 6.27 | 6.27 | 6.27 |
| | (methacrylate polyphenylene | | | | | | |
| | ether resin, SA9000) (parts by | | | | | | |
| | weight) | | | | | | |
| | Polyphenylene ether resin | 6.27 | 6.27 | 6.27 | 6.27 | 6.27 | 6.27 |
| | (oligophenylene ether, | | | | | | |
| | OPE1200) (parts by weight) | | | | | | |
| Hardened | Cyclopentadiene-styrene | 5.37 | 5.37 | 5.37 | 5.37 | 5.37 | 7.59 |
| resin | copolymer resin (SLK250) | | | | | | |
| | (parts by weight) | | | | | | |
| | Triallyl isocyanurate (TAIC) | 4.48 | 4.48 | 4.48 | 4.48 | 4.48 | 6.74 |
| | (parts by weight) | | | | | | |
| | Maleimide resin (DIC NE- | 4.48 | 0 | 0 | 0 | 0 | 0 |
| | X9470S) (parts by weight) | | | | | | |
| | Maleimide resin (DIC NE- | 0 | 4.48 | 0 | 0 | 0 | 0 |
| | X9500) (parts by weight) | | | | | | |
| | Maleimide resin (MIR3000) | 0 | 0 | 4.48 | 0 | 0 | 0 |
| | (parts by weight) | | | | | | |
| | Maleimide resin (MIR5000) | 0 | 0 | 0 | 4.48 | 0 | 0 |
| | (parts by weight) | | | | | | |
| | Maleimide resin (KI SE-55) | 0 | 0 | 0 | 0 | 4.48 | 0 |
| | (parts by weight) | | | | | | |
| | Initiator (1,3- | 0.15 | 0.15 | 0.15 | 0.15 | 0.15 | 0.15 |
| | bis(butylperoxyisopropyl) | | | | | | |
| | benzene, Perbutyl P) (parts | | | | | | |
| | by weight) | | | | | | |
| | Inorganic filler material | 70 | 70 | 70 | 70 | 70 | 70 |
| | (silicon oxide, SC2300-SVJ) | | | | | | |
| | (parts by weight) | | | | | | |

| | | | | | | |
|---|---|---|---|---|---|---|
| Electrical properties (Dk/Df) (10 GHz) | 3.04/0.0019 | 3.18/0.0026 | 2.91/0.0029 | 3.00/0.0027 | 3.08/0.0029 | 3.86/0.0034 |
| X-Y coefficient of thermal expansion (40° | 17.8 | 19.2 | 16.7 | 16.7 | 17.7 | 26.6 |
| C. to 120° C.) (ppm/° C.) | | | | | | |
| Z coefficient of thermal expansion (50° C. | 0.55 | 0.55 | 0.47 | 0.46 | 0.47 | 0.75 |
| to 260° C.) (ppm/° C.) | | | | | | |
| Glass transition temperature (° C.) | 230 | 225 | 226 | 232 | 229 | 194 |
| Roughness Ra (nm) | 189 | 179 | 195 | 201 | 191 | 489 |
| Peel strength (lbf/in) | 3.10 | 2.9 | 3.03 | 2.86 | 2.96 | 0.32 |

Based on the above, in the invention, the improved hardened resin is introduced into the resin system of the polyphenylene ether resin and the olefinic resin, and via the combination of the cyclopentadiene-styrene copolymer resin, the triallyl isocyanurate, and the maleimide resin, the resin composition may have better roughness and peel strength while maintaining low dielectric properties.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A resin composition, comprising:
a base resin comprising a polyphenylene ether resin and an olefinic resin, wherein a weight proportion of the base resin in the resin composition is between 10 wt % and 20 wt %; and
a hardened resin comprising a cyclopentadiene-styrene copolymer resin, a triallyl isocyanurate, and a maleimide resin, wherein a weight proportion of the hardened resin in the resin composition is between 10 wt % and 20 wt %.

2. The resin composition of claim 1, wherein a molecular weight of the maleimide resin is between 300 and 1800.

3. The resin composition of claim 1, wherein a weight proportion of the cyclopentadiene-styrene copolymer resin in the hardened resin is between 30 wt % and 50 wt %, a weight proportion of the triallyl isocyanurate in the hardened resin is between 25 wt % and 35 wt %, and a weight proportion of the maleimide resin in the hardened resin is between 25 wt % and 35 wt %.

4. The resin composition of claim 1, wherein the polyphenylene ether resin comprises a methacrylate polyphenylene ether resin, an oligophenylene ether, or a combination thereof, and the olefinic resin comprises an allylated phenol resin.

5. The resin composition of claim 1, further comprising an initiator, wherein a weight proportion of the initiator in the resin composition is between 0.1 wt % and 0.2 wt %.

6. The resin composition of claim 1, further comprising an inorganic filler material, wherein a weight proportion of the inorganic filler material in the resin composition is between 60 wt % and 80 wt %.

7. The resin composition of claim 1, wherein a content of the cyclopentadiene-styrene copolymer resin in the hardened resin is greater than a content of the triallyl isocyanurate in the hardened resin and a content of the maleimide resin in the hardened resin.

8. The resin composition of claim 1, wherein a content of the base resin in the resin composition is greater than a content of the hardened resin in the resin composition.

9. The resin composition of claim 1, wherein a weight proportion of the polyphenylene ether resin in the base resin is between 75 wt % and 85 wt %, and a weight proportion of the olefinic resin in the base resin is between 15 wt % and 25 wt %.

10. The resin composition of claim 1, wherein a content of the polyphenylene ether resin in the base resin is greater than a content of the olefinic resin in the base resin.
